(19) United States
(12) Patent Application Publication
(10) Pub. No.: US 2005/0213934 A1
(43) Pub. Date: Sep. 29, 2005

(54) Content reference method and system

(75) Inventor: Naoto Kinjo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/090,059

(22) Filed: Mar. 28, 2005

(30) Foreign Application Priority Data
Mar. 26, 2004 (JP) 2004-093118

(51) Int. Cl. H04N 5/76; H04N 5/781

(52) U.S. Cl. 386/46; 386/125

(57) ABSTRACT

A content reference method is provided. In this method, identification information of container medium and contents data corresponding to the contents of the container medium are stored in storage means in association with each other. The container medium is identifiable by an external appearance. The identification information of the container medium is obtained from photographic image data obtained by photographing the target container medium. When identification information of a target container medium obtained by photographing the container medium is inputted, the storage means is searched and the identification information coinciding with the inputted identification information is detected. Then, the contents data stored in association with the detected identification information is read, and contents of the target container medium are reproduced/displayed based on the read contents data.

This application claims priority on Japanese patent application No. 2004-93118, the entire contents of which are hereby incorporated by reference. In addition, the entire contents of literatures cited in this specification are incorporated by reference.

### BACKGROUND OF THE INVENTION

The present invention relates to a content reference method and a content reference system.

With enhancement of performance of personal computers, popularization of digital household electrical devices such as digital recording devices, and enhancement of performance of network systems, a so-called home network, which is constructed at home by connecting a personal computer and various household electrical devices to each other, is becoming popular, and various digital contents are mutually exchanged and are recorded/edited/reproduced.

For instance, a television set, a personal computer, and a recording device for various recording media are connected to one another, and a television program is temporarily video-recorded on a hard disk of the personal computer, is subjected to editing such as recording part selection or composition, and then is recorded on a recording medium. Alternatively, using a DVD recording device with a hard disk, a television program is first stored on the hard disk of the DVD recording device and then a part to be recorded is selected and is written onto a DVD.

In addition, it is also becoming popular, for instance, that a digital video camera, a digital still camera, or the like is connected to a home network, and an image photographed by a user is recorded on a CD-R, a DVD, or the like as it is or after being edited; or music data delivered through the Internet or music data created by a user is recorded on a recording medium such as a CD-R or an MD.

On the other hand, recording media are increasing in capacity and it is currently possible to record great many contents on one recording medium. In addition, recording media such as DVD-RWs, CD-RWs, and MDs are rewritable. Although such recording media are very useful in data recording, there is a problem in that inconvenience occurs at the time of data management and search because it is impossible to know what contents are recorded on the recording media unless the recording media are loaded into reproduction devices.

Conventionally, information describing contents recorded on a recording medium has been written on a label of the recording medium. However, the label information writing is very cumbersome work. Moreover, the amount of the information that can be written on the label is very small, so it is difficult to precisely recognize the recorded contents afterward by referring to the information written on the label, and it is impossible to write the whole of necessary information when the number of the recorded contents is large. Also, coincidence between the information written on the label and the recorded contents is lost when the contents are rewritten after the label information writing.

JP 2003-101922 A discloses a technique with which in order to make it possible to confirm video-recorded contents without reproducing a video tape, a still image (such as an index image) at the time of start of recording on the video tape is recorded using a camera-integrated magnetic recording device and is written into a semiconductor memory built in the cassette tape, thereby making it possible to record the still image surely and easily and reproduce the still image quickly at the time of confirmation of the contents of the video tape.

It is said that with the camera-integrated magnetic recording device, the necessity to write information describing the video-recorded contents on a label or the like is eliminated and it becomes possible to confirm the video-recorded contents by referring to the still image. In this case, however, it is required to embed the semiconductor memory in the cassette tape, so there is a problem in that an increase in cost of the cassette tape is inevitable. Also, it is required to load the cassette tape into a reading device at the time of the confirmation of the video-recorded contents, so there is another problem in that the video-recorded contents confirmation takes considerable time and effort.

Also, JP 2002-245747 A discloses a technique with which an image display portion is integrated with a recording medium by attaching an image display element to the exterior portion of the recording medium and data contents recorded on the recording medium are displayed on the image display portion, thereby making it possible to confirm the contents of the recording medium with ease. In this case, however, the hardware for the recording medium is required to have a dedicated recording device for recording into the image display element, so there is a problem in that the hardware for the recording medium becomes complicated and an increase in cost is inevitable.

### SUMMARY OF THE INVENTION

The present invention has been made in order to solve the problems of the conventional techniques described above, and therefore has an object to provide a content reference method and system that when contents composed of digital data are recorded on a recording medium, allow a user to manage the recorded contents with ease and precision by eliminating the necessity to conduct cumbersome work, such as writing of information describing the recorded contents onto a label of the recording medium in detail, and by preventing the recording medium and a recording device therefor from becoming complicated and increasing in cost, and also allow the user to recognize the recorded contents with ease by eliminating the necessity to load the recording medium into a device.

Also, the present invention has another object to provide a content reference method and system that even when contents of articles are contained in a container medium such as a container case, allow a user to manage the contents (contained articles) with ease and precision and recognize the contained articles with ease by eliminating the necessity to conduct cumbersome work, such as writing of information describing the contained articles on a label in detail, and the necessity to search the inside of the container medium.

In order to achieve the above-mentioned object, the present invention provides a content reference method comprising: obtaining identification information of container medium in which contents are contained and which is identifiable by an external appearance thereof from photographic image data obtained by photographing the container medium; storing the obtained identification information and contents data corresponding to the contents of the container medium in storage means in association with each other; searching, when identification information of a certain container medium obtained by photographing the container medium is inputted, the storage means using the inputted identification information and detecting the identification information coinciding with the inputted identification information; reading, from the storage means, the contents data stored in association with the detected identification information; and reproducing/displaying contents of the certain container medium based on the read contents data.

Also, the present invention provides a content reference method comprising: obtaining photographed image data that is obtained by photographing container medium in which contents are contained and which is identifiable by an external appearance thereof, as identification information of the container medium; storing the obtained identification information and contents data corresponding to the contents of the container medium in storage means in association with each other; searching, when the contents data is inputted, the storage means using the inputted contents data and detecting the contents data coinciding with the inputted contents data; reading, from the storage means, the identification information stored in association with the detected contents data; and reproducing/displaying photographic image of the certain container medium based on the read identification information.

Preferably, the contents are composed of digital data; the container medium is a recording medium for the digital data; and the contents data is outline data of the digital data of the contents.

Preferably, the photographing of the container medium for the obtainment of the identification information and one of the reproduction/display of the contents and reproduction/display of a photographed image of the container medium are performed by a portable device having a photographing function, a reproduction/display function, and a transmission/reception function.

Also, the present invention provides a content reference system comprising: photographing means for photographing container medium in which contents are contained and which is identifiable by an external appearance thereof; obtainment means for obtaining identification information of the container medium from photographic image data obtained by the photographing means; storage means for storing the obtained identification information and contents data corresponding to the contents of the container medium in association with each other; detection means for searching the storage means using the identification information of the container medium obtained by the obtainment means and detecting identification information coinciding with the obtained identification information; reading means for reading, from the storage means, the contents data stored in association with the identification information detected by the detection means; and reproducing/displaying means for reproducing/displaying the contents based on the contents data read by the reading means.

Preferably, the photographing means and the reproduction/display means are implemented by a portable device having a photographing function, a reproduction/display function, and a transmission/reception function.

Also, the present invention provides a content reference system comprising: photographing means for photographing container medium in which contents are contained and which is identifiable by an external appearance thereof; obtainment means for obtaining photographic image data obtained by the photographing means as identification information of the container medium; storage means for storing the obtained identification information and contents data corresponding to the contents of the container medium in association with each other; reproduction/display means for reproducing/displaying the contents based on the contents data; designation means for designating certain contents from among multiple contents reproduced/displayed by the reproduction/display means; detection means for searching the storage means using the contents data of the contents designated by the designation means and detecting contents data coinciding with the contents data of the designated contents; reading means for reading, from the storage means, identification information of a container medium stored in association with the contents data detected by the detection means; and image display means for reproducing/displaying a photographic image of the container medium based on the identification information read by the reading means.

Preferably, the photographing means, the reproduction/display means, and the image display means are implemented by a portable device having a photographing function, a reproduction/display function, and a transmission/reception function.

Preferably, the content reference system further comprises writing means for writing the identification information obtained by the obtainment means into the storage means in association with the contents data.

Preferably, the content reference system further comprises recording means for recording the contents onto the container medium and generating recording processing information of the contents, wherein the writing means writes the contents data and the identification information into the storage means in association with each other based on the recording processing information.

Preferably, the contents are composed of digital data, the container medium is a recording medium for the digital data, and the contents data is outline data of the digital data of the contents.

According to the present invention, recorded contents of a recording medium are stored as a set with identification information of the recording medium at a home server, so even when many contents are recorded on the recording medium or the contents are rewritten, it becomes possible to manage the recorded contents of the recording medium with precision.

Also, the identification information of the recording medium is obtained by photographing the external appearance of the recording medium, so it becomes possible to manage the recorded contents of the recording medium with ease by eliminating the necessity to conduct cumbersome work such as writing of information describing the recorded contents onto a label of the recording medium in detail.

Further, according to the present invention, the recorded contents of the recording medium are managed using the photographed image of the recording medium as the identification information, so it becomes possible to recognize the recorded contents of the recording medium with ease by photographing the recording medium using a portable device with a photographing function or the like and reproducing outline data of the recorded contents using the portable device with reference to an image obtained through the photographing, which eliminates the necessity to load the recording medium into a device.

Still further, according to the present invention, identification information of an container medium, such as an container case, and identification information of its contents (contained articles) are obtained by photographing the container medium and the contents and are stored as a set at a home server, so it becomes possible to manage the contained articles of the container medium with ease and it also becomes possible to recognize the contained article with ease through displaying of a photographed image.

### BRIEF DESCRIPTION OF THE DRAWINGS

FIGS. 1A to 1C are each a conceptual diagram showing a schematic construction of a first embodiment of the content reference system according to the present invention that implements the content reference method according to the present invention;

FIGS. 2A and 2B are each a conceptual diagram showing a schematic construction of a second embodiment of the content reference system according to the present invention;

FIGS. 3A to 3C are each a conceptual diagram showing a schematic construction of a third embodiment of the content reference system according to the present invention;

FIGS. 4A to 4C are each a conceptual diagram showing a schematic construction of a fourth embodiment of the content reference system according to the present invention;

FIGS. 5A to 5D are each a conceptual diagram showing a schematic construction of a fifth embodiment of the content reference system according to the present invention;

FIG. 6 shows an example of a system construction for recording medium search by the content reference system in the first embodiment;

FIGS. 7A and 7B each show an example of displaying of a result of the recording medium search;

FIG. 8 shows another example of the system construction for the recording medium search by the content reference system in the first embodiment;

FIG. 9 shows still another example of the system construction for the recording medium search by the content reference system in the first embodiment;

FIG. 10 shows an example of a system construction for recording medium search by the content reference system in the third embodiment or the content reference system in the fourth embodiment;

FIGS. 11A to 11C are each a conceptual diagram showing a schematic construction of a sixth embodiment of the present invention;

FIGS. 12A and 12B are each an explanatory diagram of a print addition method in the content reference system shown in FIGS. 11A to 11C;

FIGS. 13A and 13B are each an explanatory diagram of a print deletion method in the content reference system shown in FIGS. 11A to 11C;

FIG. 14 is an explanatory diagram of a contained file search method in the content reference system shown in FIGS. 11A to 11C;

FIGS. 15A to 15C are each a conceptual diagram showing a schematic construction of a seventh embodiment of the present invention; and

FIGS. 16A and 16B are each a conceptual diagram showing another schematic construction of the seventh embodiment of the present invention.

### DETAILED DESCRIPTION OF THE PREFERRED EMBODIMENTS

The content reference method and system according to the present invention will now be described in detail based on preferred embodiments illustrated in the accompanying drawings.

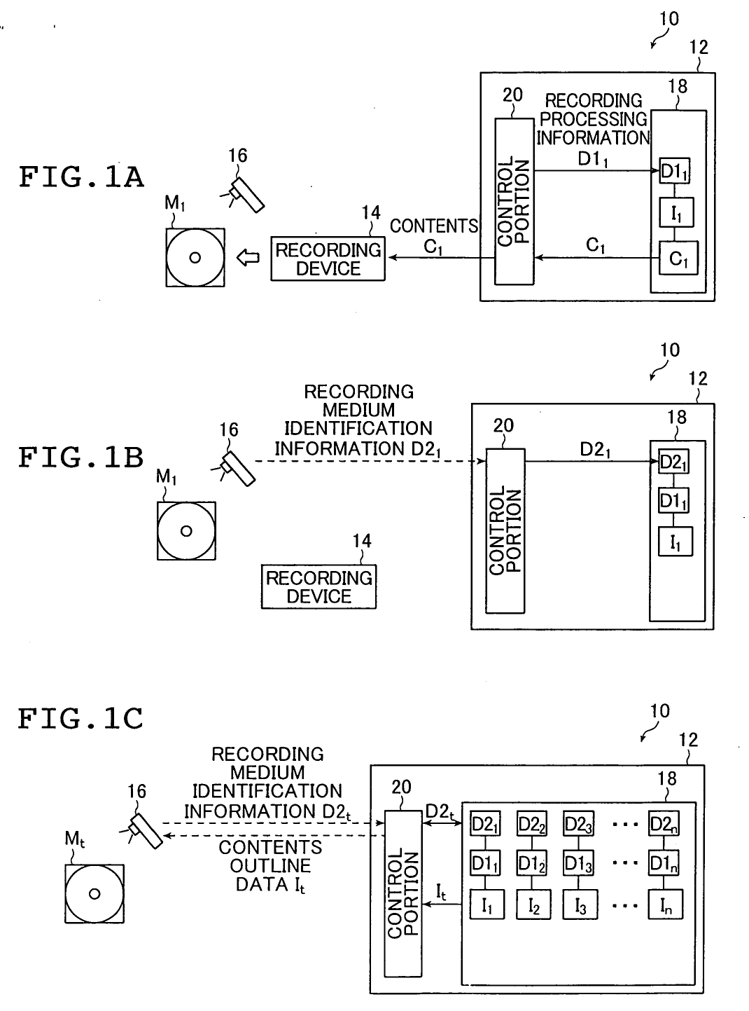

To begin with, a first embodiment of the present invention will be described. FIGS. 1A to 1C are each a conceptual diagram showing a schematic construction of the first embodiment of the content reference system according to the present invention that implements the content reference method according to the present invention. A content reference system 10 shown in the drawings includes a home server 12, a recording device 14, and a portable device 16. In the content reference system 10, when contents main body data C stored in the home server 12 is recorded on a recording medium M by the recording device 14, photographed image data of the recording medium M, on which the contents main body data C is recorded, is set as identification information D2 of the recording medium M and the identification information D2 and outline data I of the contents main body data C are stored and accumulated in the home server 12 so as to be associated with each other. Following this, when it is desired to know the contents of the recording medium M, search of data accumulated in the home server 12 is performed using the identification information D2 of the recording medium M as a key and the outline data I of the contents main body data C recorded on the recording medium M is detected and displayed.

The contents main body data C(hereinafter simply referred to as the “contents C”) is a digital file of image data, sound data, program data, or the like constituting contents such as a moving image, a still image, sound, music, or a program.

The contents outline data I is data with which it is possible to grasp the outline of the contents C plainly and is data of the same type as the contents C and whose size is significantly reduced from that of the contents C. For instance, the contents outline data I is abstract data, compressed data, or the like generated from the contents C or obtained at the time of obtainment of the contents C. More specifically, when the contents C are moving image data, the contents outline data I is moving image data of a highlight scene selected in advance, a header scene of each chapter, or the like or still image data of an index image or the like, for instance. Also, when the contents C are still image data, the contents outline data I is reduced image data constituting a thumbnail or the like, for instance. Further, when the contents C are sound data, the contents outline data I is sound data, such as abstract data at a predetermined position, for instance. Still further, when the contents C are a program, the contents outline data I is partial data of the program.

The home server 12 includes a storage portion 18 and a control portion 20 and is connected to the recording device 14 through a not-shown connection portion for data exchange with the outside. Also, the home server 12 includes a not-shown display portion (monitor) and an instruction input means. Further, in addition to the recording device 14, various household electrical devices, such as a television set, a printer, a digital camera, and a personal computer, may be connected to the home server 12. The home server 12 has a function of managing the recording device 14 and can be constructed using a relatively high-performance personal computer or the like. Note that when devices other than the recording device 14 are connected to the home server 12, the home server 12 may have a function of managing the devices.

In the storage portion 18, a digital file of digital image data, sound data, a program, or the like obtained or created by a household electrical device connected to the home server 12 is stored as the contents C (C₁, C₂, C₃, . . . , Cₙ). In addition, in the storage portion 18, the outline data I (I₁, I₂, I₃, . . . , Iₙ) of the contents C is also stored. The contents C and the contents outline data I are dealt with as separated information and even when the contents C are erased from the storage portion 18, the contents outline data I is maintained in the storage portion 18 until erase processing is intentionally performed by a user.

The control portion 20 performs various kinds of data processing, such as data writing, reading, editing, and search/detection, with respect to the storage portion 18 at the home server 12 and also performs control of data exchange with external devices. Also, the control portion 20 controls the recording device 14 connected to the home server 12.

The recording device 14 records the sent contents C onto the recording medium M as it is or after editing in accordance with control from the control portion 20 of the home server 12. As examples of the recording medium M, it is possible to cite optical recording media, such as a DVD-R, a CD-R, and an MD, and magnetic recording media such as a magnetic disk and a magnetic tape. Note that the recording device 14 is, for instance, a DVD recording device with a hard disk constructed integrally with the home server 12.

The portable device 16 has a photographing function, a reproduction/display function for images and sound, and a transmission/reception function and is a portable device that is capable of exchanging data with the home server 12. Also, the portable device 16 obtains the identification information D2 of the recording medium M by photographing the external appearance of the recording medium M and transfers the identification information D2 to the home server 12. Further, the portable device 16 receives data transferred from the home server 12 and reproduces/displays an image or sound (music). Data exchange between the portable device 16 and the home server 12 may be performed in a wired manner, although it is preferable that the data exchange is performed in a wireless manner in terms of portability of the portable device 16. As examples of the wireless communication, it is possible to cite direct communication performed using a LAN, BlueTooth (registered trademark), infrared rays, or the like and communication performed through a mobile telephone line, the Internet, or the like. Also, as examples of the portable device 16, it is possible to cite a mobile telephone with a camera, a digital camera with a communication function, and the like.

Next, an operation of the content reference system 10 will be described.

FIG. 1A shows a step (recording step) where the contents C stored in the home server 12 are recorded on the recording medium M by the recording device 14.

At the time of recording, the contents C₁ stored in the storage portion 18 are read by the control portion 20, are transmitted to the recording device 14, and are recorded on the recording medium M₁ at the recording device 14. When doing so, at the control portion 20, recording processing information D1₁ that is information concerning the contents C₁ recorded on the recording medium M₁ by the recording device 14 is created. The created recording processing information D1₁ is stored in the storage portion 18 so as to be associated with the outline data I₁ of the contents C₁ stored in the storage portion 18.

The recording processing information D1₁ is preferably composed of, for instance, time information preferably in units of seconds, which shows a time of recording processing by the recording device 14, a time of ejection of the recording medium M₁ from the recording device 14 after recording, or the like, and contents identification information such as the contents name of the contents C₁ (when multiple contents C are recorded, multiple contents names are obtained for the respective contents C). Alternatively, when no overlapping contents C exist, for instance, one of the time information and the contents name may be set as the recording processing information D1₁.

The contents C₁ read from the storage portion 18 for recording onto the recording medium M₁ are automatically erased from the storage portion 18 or is erased in accordance with an instruction from a user. Even when the contents C₁ are erased from the storage portion 18, the outline data I₁ and the recording processing information D1₁ thereof are maintained in the storage portion 18.

FIG. 1B shows a step (registration step) where identification information D2₁ of the recording medium M₁, on which the contents C₁ are recorded, is obtained and is stored and accumulated in the home server 12 as a set with the recording processing information D1₁ created at the time of the recording and stored in the storage portion 18.

The external appearance of the recording medium M₁, on which the contents C₁ are recorded by the recording device 14 and which is ejected from the recording device 14, is photographed by the portable device 16. Photographed image data of the recording medium M₁ obtained by the portable device 16 is transferred from the portable device 16 to the home server 12 as the identification information D2₁ of the recording medium. At the home server 12, the identification information D2₁ of the recording medium is received by the control portion 20 and is stored (registered) in the storage portion 18 as a set with the recording processing information D1₁ stored in the storage portion 18 in advance.

Here, it is required that it is possible to identify respective recording media M (M₁, M₂, M₃, . . . , Mₙ) using their external appearance images (photographed image data), so it is required that the colors, labels, or the like of the recording media are different from each other. For instance, labels are stuck onto the recording media M and different characters, numbers, or codes like barcodes are printed onto the respective labels or different messages are written thereonto by hand. It is sufficient that the sticking of the labels and the printing or writing onto the labels are performed before the recording media M are photographed in order to obtain the identification information D2 of the recording media. In addition, for instance, it is also preferable that the recording media M are provided under a state where different signs or the like are given.

In the manner described above, each time the contents C (C₁, C₂, C₃, . . . , Cₙ) stored in the storage portion 18 are recorded on the recording media M (M₁, M₂, M₃, . . . , Mₙ) the recording processing information D1 (D1₁, D1₂, D1₃, . . . , D1ₙ) and the identification information D2 (D2₁, D2₂, D2₃, . . . , D2ₙ) of the recording media are generated and are stored in the storage portion 18 so as to be associated with the outline data I (I₁, I₂, I₃, . . . , Iₙ) of the contents C. As a result, the outline data I of the contents C and the identification information D2 of the recording media M, on which the contents C are recorded, are accumulated in the storage portion 18.

FIG. 1C shows a step (reference step) where when it is desired to know the recorded contents (contents C) of the recording medium Mₜ, the inside of the home server 12 is searched using the identification information D2ₜ of the recording medium Mₜ as a key and the outline data Iₜ of the contents Cₜ recorded on the recording medium Mₜ are detected and displayed.

After the contents C are recorded on the recording media M and the outline data I of the contents C and the information (D1 and D2) associated therewith are accumulated in the storage portion 18 in the manner described above, when it is desired to know the recorded contents (contents Cₜ) of the recording medium Mₜ, first, the external appearance of the recording medium Mₜ that is a target medium is photographed using the portable device 16 and its photographed image data is transferred to the home server 12 as the identification information D2ₜ of the recording medium.

Here, in order to distinguish between the transfer of the identification information D2ₜ of the recording medium at the time of the reference and the transfer of the identification information D2 at the time of the registration described above, a selection from among a reference mode and a registration mode is made through setting on at least one of the portable device 16 and the home server 12 prior to the data transfer from the portable device 16.

At the home server 12, the control portion 20 compares the transferred identification information D2ₜ of the recording medium with each piece of data in an identification information D2 group (D2₁ to D2ₙ) of N recording media stored in the storage portion 18 and detects identification information, whose image characteristic amount is the most similar to that of the identification information D2ₜ, or identification information, whose code/character contents coincide with those of the identification information D2ₜ, from the identification information D2 group.

When the identification information D2 (D2ₜ) corresponding to the identification information D2ₜ is detected, the contents outline data Iₜ corresponding to the recording processing information D1ₜ stored as a set with the detected identification information D2ₜ is returned to the portable device 16. Then, at the portable device 16, the contents outline data Iₜ is reproduced.

The contents outline data I is reproduced as a still image, a moving image, a text, sound (music), or a combination thereof. More specifically, in accordance with the kind of the contents outline data I and the function of the portable device 16, an image is displayed on a display portion (not shown) of the portable device 16 and/or sound is emitted from the portable device 16. For instance, the portable device 16 displays an index image, a short moving image with sound, or the like or reproduces a beginning portion of a song or the like. It is possible for the user to recognize the recorded contents (contents Cₜ) of the recording medium Mₜ by means of the reproduced information.

In addition, when the contents C are moving image data, it is also preferable that the contents outline data I has a hierarchical structure (tree structure) described below. That is, on the display portion of the potable device 16, an index of the recorded multiple moving image contents C is first displayed. When specific contents C are designated using the displayed index, a representative frame of each chapter of the designated contents is next index-displayed. When a specific chapter is further designated, a simplified moving image (low-quality and short-time moving image) of the chapter is reproduced. It is also preferable that the reproduced moving image is a moving image with sound.

Alternatively, it is also preferable that recording time information or additional information of the respective contents is further reproduced/displayed. As examples of the additional information, it is possible to cite the title, broadcast channel, or the like of a television program in the case of telerecording and it is possible to cite a photographing date and time, a photographing place, or the like in the case of a moving image photographed by a user. In addition, it is also preferable that information showing the remaining amount of the recording capacity of the recording medium M is reproduced/displayed.

It is preferable that the contents outline data Iₜ is reproduced by the portable device 16 that obtained the identification information D2ₜ of the recording medium Mₜ in terms of user's convenience. However, when many images are reproduced from the contents outline data Iₜ, for instance, the images may be displayed on another monitor managed by the home server 12. In addition, together with the contents outline data Iₜ, the recording processing information D1ₜ may be converted into characters and displayed as the characters.

It should be noted here that in the embodiment described above, the photographed image data of the recording medium M obtained by the portable device 16 is stored in the storage portion 18 as it is as the identification information D2 of the recording medium, but a form may be used in which image analysis result data of the photographed image data of the recording medium M is stored in the storage portion 18 as the identification information D2.

For instance, a form may be used in which at the time of registration, the control portion 20 performs code/character recognition of the photographed image data of the recording medium M transferred from the portable device 16 and stores result data of the recognition in the storage portion 18 as the identification information D2. In this case, at the time of reference, the control portion 20 performs code/character recognition of the photographed image data of the recording medium Mₜ transferred from the portable device 16, compares result data of the code/character recognition with the identification information D2 stored in the storage portion 18, and detects the identification information D2 whose code/character contents coincide with those of the code/character recognition result data.

Alternatively, a form may be used in which a code/character recognition function is provided for the portable device 16 and both at the time of registration and at the time of reference, the portable device 16 obtains the photographed image data of the recording medium M, performs the code/character recognition, and transfers the obtained code/character recognition result data to the home server 12 as the identification information D2. In this case, at the time of registration, the identification information D2 that is the code/character recognition result data transferred from the portable device 16 is accumulated in the storage portion 18 as it is. Also, at the time of reference, the control portion 20 compares the identification information D2ₜ that is the code/character recognition result data transferred from the portable device 16 with the identification information D2 stored in the storage portion 18 and detects the identification information D2 whose code/character contents coincide with those of the identification information D2ₜ.

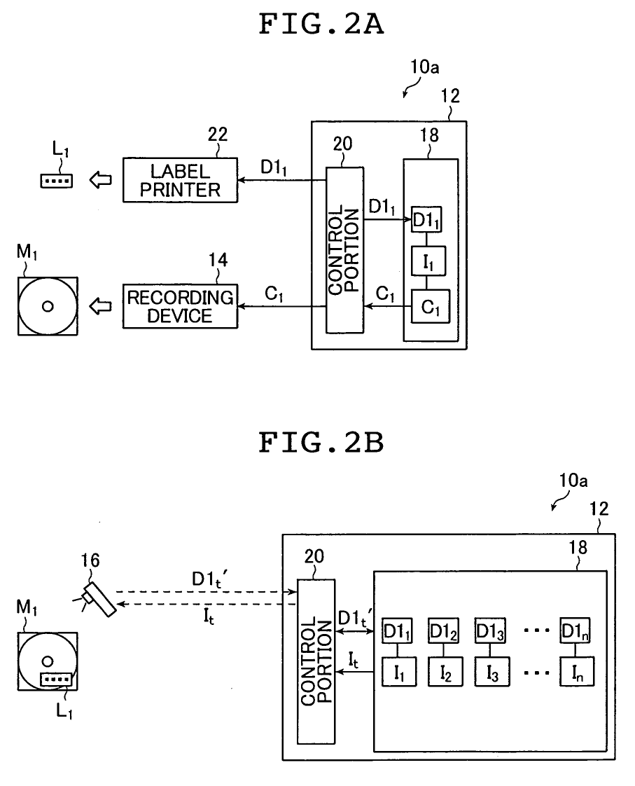

Next, a second embodiment of the present invention will be described. FIGS. 2A and 2B are each a conceptual diagram showing a schematic construction of the second embodiment of the content reference system according to the present invention. A content reference system 10a shown in the drawings has basically the same construction as the content reference system 10 shown in FIGS. 1A to 1C except that a label printer 22 is provided in the content reference system 10a shown in FIGS. 2A and 2B. Therefore, each same element is given the same reference numeral and the description thereof will be omitted. The content reference system 10a differs from the content reference system 10 shown in FIGS. 1A to 1C in that a label L is created using recording processing information D1 obtained at the time of recording of contents C onto a recording medium M and is stuck onto the recording medium M and the recording medium M is photographed, thereby obtaining data corresponding to the recording processing information D1 from photographed image data.

The label printer 22 is connected to a home server 12 and is a printer that prints inputted information on a label as visual information and outputs the label in accordance with control from a control portion 20 of the home server 12.

First, an operation of the content reference system 10a at the time of recording onto and registration of the recording medium M will be described with reference to FIG. 2A.

Like in the case of the content reference system 10 described above, at the time of recording, contents C₁ stored in a storage portion 18 are transmitted to a recording device 14 in accordance with control from the control portion 20 and are recorded on a recording medium M₁ by the recording device 14. In addition, at the control portion 20, recording processing information D1₁ concerning the recorded contents C₁ is created and is stored in the storage portion 18 so as to be associated with outline data I₁ of the contents C₁ stored in the storage portion 18. When doing so, in this embodiment, the recording processing information D1₁ is outputted also to the label printer 22.

The label printer 22 performs label print based on the recording processing information D1₁ transmitted from the control portion 20 and outputs the label L₁. Information printed on the label L₁ is not limited to the recording processing information D1₁ itself and may be an identification code that uses a part of data of the recording processing information D1₁, an identification number created based on the recording processing information D1₁, or the like.

The recording medium M₁, on which the contents C₁ are recorded, is ejected from the recording device 14 and the corresponding label L₁ is outputted from the label printer 22. Then, the label L₁ is stuck onto the recording medium M₁. Through the processing described above, the recording onto and registration of the recording medium M₁ are completed.

Next, an operation of the content reference system 10a at the time of referring to the recorded contents of the recording medium M will be described with reference to FIG. 2B.

When it is desired to refer to the recorded contents (contents Cₜ) of the recording medium Mₜ, first, a part, which contains at least the label L₁, of the external appearance of the recording medium Mₜ that is a target medium is photographed by the portable device 16 and a result of the photographing is transferred to the home server 12 as recording processing information D1ₜ′. Then, the control portion 20 performs recognition of a code, character, or the like printed on the label L₁ using the recording processing information D1ₜ′ transferred from the portable device 16, compares obtained code/character recognition result data with recording processing information D1 group stored in the storage portion 18, and detects recording processing information D1 (that is, D1ₜ) corresponding to the code/character recognition result data of the recording processing information D1ₜ′.

Following this, in the same manner as in the case of the content reference system 10 described above, contents outline data Iₜ corresponding to the recording processing information D1ₜ is returned to the portable device 16 and is reproduced at the portable device 16.

It should be noted here that like in the example described above, a form may be used in which a code/character recognition function is provided for the portable device 16 and code/character recognition result data obtained from the photographed image data of the recording medium M is transferred from the portable device 16 to the home server 12 as the recording processing information D1ₜ.

Also, in this embodiment, the transfer of the recording processing information D1ₜ from the portable device 16 is performed only at the time of the referring, so the selection from among the reference mode and the registration mode performed in the example described above becomes unnecessary.

Further, according to this embodiment, the label L corresponding to the recording of the contents C onto the recording medium M is outputted and is stuck onto the recording medium M, so it becomes possible to use multiple recording media M having the same external appearance.

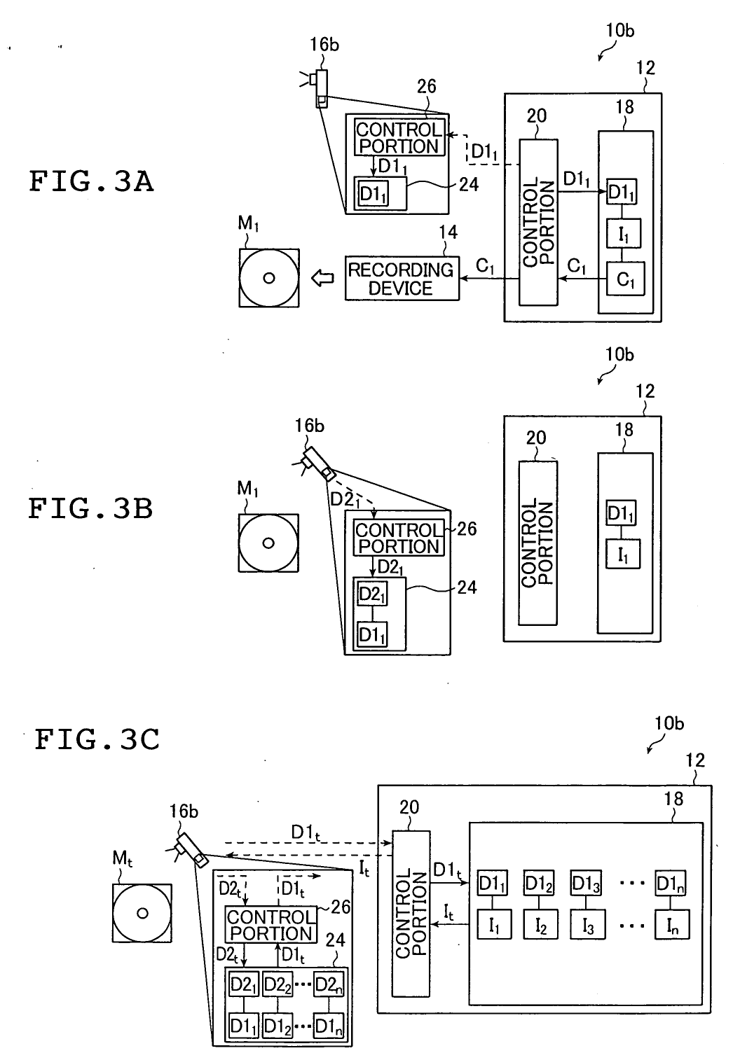

Next, a third embodiment of the present invention will be described. FIGS. 3A to 3C are each a conceptual diagram showing a schematic construction of the third embodiment of the content reference system according to the present invention. A content reference system 10b shown in the drawings has basically the same construction as the content reference system 10 shown in FIGS. 1A to 1C except that a portable device 16b includes a storage portion 24 that stores recording processing information D1 and identification information D2 therein and a control portion 26 that controls input/output of data with respect to the storage portion 24 and the like. Therefore, each same element is given the same reference numeral and the description thereof will be omitted.

The content reference system 10b differs from the content reference system 10 shown in FIGS. 1A to 1C in the following point. That is, in the content reference system 10, the identification information D2 is stored in the storage portion 18 of the home server 12. In contrast to this, in the content reference system 10b, the identification information D2 is stored in the storage portion 24 of the portable device 16b and the identification information D2 coinciding with the identification information D2ₜ is searched for in the portable device 16b.

The portable device 16b has the same function as the portable device 16 of the content reference system 10 shown in FIGS. 1A to 1C and additionally includes the storage portion 24 and the control portion 26 as described above.

FIG. 3A shows an operation of the content reference system 10b at the time of recording onto the recording medium M.

Like in the case of the content reference system 10 described above, at the time of recording, contents C₁ stored in a storage portion 18 is transmitted to a recording device 14 in accordance with control from a control portion 20 and is recorded onto a recording medium M₁ by the recording device 14. In addition, the control portion 20 generates recording processing information D1₁ concerning the recorded contents C₁ and stores the generated recording processing information D1₁ in the storage portion 18 so as to be associated with outline data I₁ of the contents C₁ stored in the storage portion 18. When doing so, in this embodiment, the recording processing information D1₁ is transferred also to the portable device 16b.

The recording processing information D1₁ transferred to the portable device 16 is stored in the storage portion 24 by the control portion 26.

FIG. 3B shows an operation of the content reference system 10b at the time of registration of information concerning the recording medium M and the recorded contents thereof.

The external appearance of the recording medium M₁, on which the contents C₁ are recorded by the recording device 14 and which is ejected from the recording device 14, is photographed by the portable device 16b set in a registration mode, thereby obtaining photographed image data as identification information D2₁. The identification information D2₁ is inputted into the control portion 26 in the portable device 16b and is stored (registered) in the storage portion 24 by the control portion 26 as a set with the recording processing information D1₁ stored in the storage portion 24 in advance.

By repeating the recording/registration processing shown in FIGS. 3A and 3B, multiple pieces of contents outline data I and multiple pieces of recording processing information D1 of multiple contents C are accumulated in the storage portion 18 of the home server 12 and the recording processing information D1 of the multiple contents C and the identification information D2 of multiple recording media M, on which the contents C are recorded, are accumulated in the storage portion 24 of the portable device 16.

FIG. 3C shows an operation of the content reference system 10b at the time of referring to the recorded contents of the recording medium M.

When it is desired to refer to the recorded contents (contents Ct) of the recording medium Mₜ, first, the portable device 16b is switched to a reference mode and the external appearance of the recording medium Mₜ that is a target medium is photographed using the portable device 16b. Then, a photographed image of the recording medium Mₜ is inputted into the control portion 26 of the portable device 16b as identification information D2ₜ.

Then, the control portion 26 compares the inputted identification information D2ₜ with each piece of data in the identification information D2 group (D2₁ to D2ₙ) stored in the storage portion 24 and detects identification information, whose image characteristic amount is the most similar to that of the identification information D2ₜ, or identification information, whose code/character contents coincide with those of the identification information D2ₜ, from the identification information D2 group. When the identification information D2 (that is, D2ₜ) corresponding to the identification information D2ₜ is detected, recording processing information D1ₜ stored as a set with the detected identification information D2ₜ is read from the storage portion 24 and is transferred to the home server 12.

Next, at the home server 12, the control portion 20 receives the transferred recording processing information D1ₜ, detects recording processing information D1 (that is, D1ₜ) coinciding with the received recording processing information D1ₜ from the storage portion 18, reads contents outline data Iₜ corresponding to the recording processing information D1ₜ, and returns the read contents outline data Iₜ to the portable device 16b. Then, at the portable device 16, in the same manner as in each example described above, the contents outline data Iₜ is reproduced and a user knows the recorded contents of the recording medium Mₜ by referring to the reproduced contents outline data Iₜ.

It should be noted here that it is also preferable that at the time of recording, access destination information at the home server 12 is additionally stored in the storage portion 24 of the portable device 16b as the recording processing information D1. In this case, at the time of reference, it becomes possible to directly obtain the contents outline data Iₜ without performing the detection of the recording processing information D1ₜ by the control portion 20.

Also, a form may be used in which a code/character recognition function is provided for the portable device 16, code/character recognition result data obtained from the photographed image data of the recording medium M is accumulated in the storage portion 24 as the identification information D2, and search processing is performed using the identification information D2.

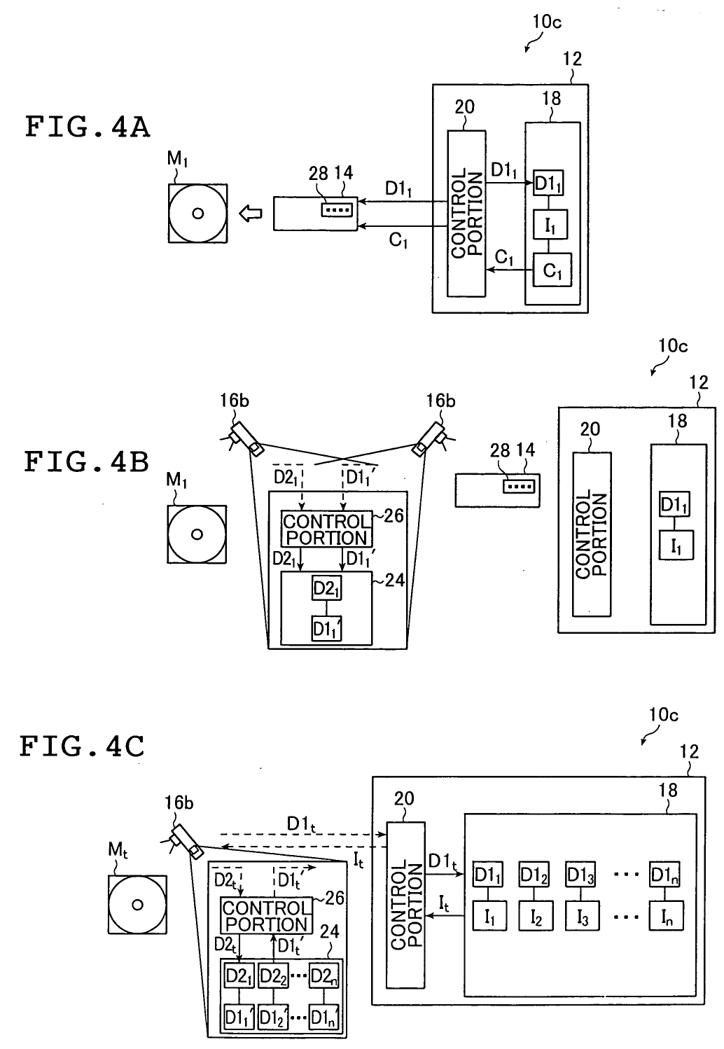

Next, a fourth embodiment of the present invention will be described. FIGS. 4A to 4C are each a conceptual diagram showing a schematic construction of the fourth embodiment of the content reference system according to the present invention. A content reference system 10c shown in the drawings has basically the same construction as the content reference system 10b shown in FIGS. 3A to 3C. That is, as the portable device 16, a portable device 16b is used which includes a storage portion 24 and a control portion 26. Also, a display panel 28 is provided for a recording device 14. Note that each element of the content reference system 10c shown in FIGS. 4A to 4C that is the same as that of the content reference system 10b shown in FIGS. 3A to 3C is given the same reference numeral and the description thereof will be omitted.

The content reference system 10c differs from the content reference system 10b shown in FIGS. 3A to 3C in that information serving as the identification information of a recording medium M is displayed on the display panel 28 of the recording device 14 using recording processing information D1 obtained at the time of recording of contents C onto the recording medium M and data obtained by photographing the display panel 28 using the portable device 16b is set as recording processing information D1′ and is used as information for associating the recording medium M and contents outline data I with each other.

As shown in FIG. 4A, at the time of recording onto the recording medium M, in accordance with control from a control portion 20, contents C₁ stored in a storage portion 18 are transmitted to the recording device 14 and are recorded on a recording medium M₁ by the recording device 14. When doing so, the control portion 20 generates recording processing information D1₁ concerning the recorded contents C₁. The generated recording processing information D1₁ is stored in the storage portion 18 so as to be associated with outline data I₁ of the contents C₁ stored in the storage portion 18 and is also outputted to the recording device 14.

Then, at the recording device 14, an identification code that uses a part or all of the recording processing information D1₁ sent from the control portion 20 or an identification number, a character, or the like created based on the recording processing information D1₁ is displayed on the display panel 28.

Next, as shown in FIG. 4B, the external appearance of the recording medium M₁, on which the contents C₁ are recorded by the recording device 14 and is ejected from the recording device 14, is photographed by the portable device 16b set in a registration mode, thereby obtaining identification information D2₁ of the recording medium M₁. In addition, the display panel 28, on which information based on the recording processing information D1₁ is displayed, is photographed by the portable device 16b, thereby obtaining photographed image data that is recording processing information D1₁′. Following this, at the portable device 16b, the identification information D2₁ and the recording processing information D1₁′ are stored (registered) in the storage portion 24 as a set.

When it is desired to confirm the recorded contents of a recording medium Mₜ, as shown in FIG. 4C, the external appearance of the recording medium Mₜ is photographed by the portable device 16b switched to a reference mode and obtained identification information D2ₜ is inputted into the control portion 26 of the portable device 16b. Then, the control portion 26 checks the identification information D2ₜ against each piece of identification information D2 in an identification information D2 group stored in the storage portion 24 and detects the identification information D2 (that is, D2ₜ) whose information coincides with that of the identification information D2ₜ. Next, the control portion 26 reads recording processing information D1ₜ′ that is a set with the identification information D2ₜ detected from the storage portion 24 and transfers the information D1ₜ′ to the home server 12.

Then, at the home server 12, the control portion 20 receives the recording processing information D1ₜ′. The recording processing information D1ₜ′ is photographed image data of information displayed on the display panel 28 based on recording processing information D1₁, so data corresponding to the recording processing information D1₁ (a part or all thereof) is obtained through character/code recognition by the control portion 20. Then, the control portion 20 finds corresponding recording processing information D1ₜ from a recording processing information D1 group stored in the storage portion 18 with reference to result data of the character/code recognition of the recording processing information D1ₜ′ and returns contents outline data It corresponding to the recording processing information D1ₜ to the portable device 16b. Then, at the portable device 16b, in the same manner as in each example described above, the contents outline data Iₜ is reproduced and a user knows the recorded contents of the recording medium Mₜ by referring to the reproduced contents outline data Iₜ.

In this embodiment, when a character/code recognition function is provided for the portable device 16b, it is sufficient that the data obtained through the character/code recognition of the recording processing information D1′ obtained by photographing the display panel 28 of the recording device 14 using the portable device 16b is set as the recording processing information D1 and the recording processing information D1 and the identification information D2 are stored in the storage portion 24 as a set.

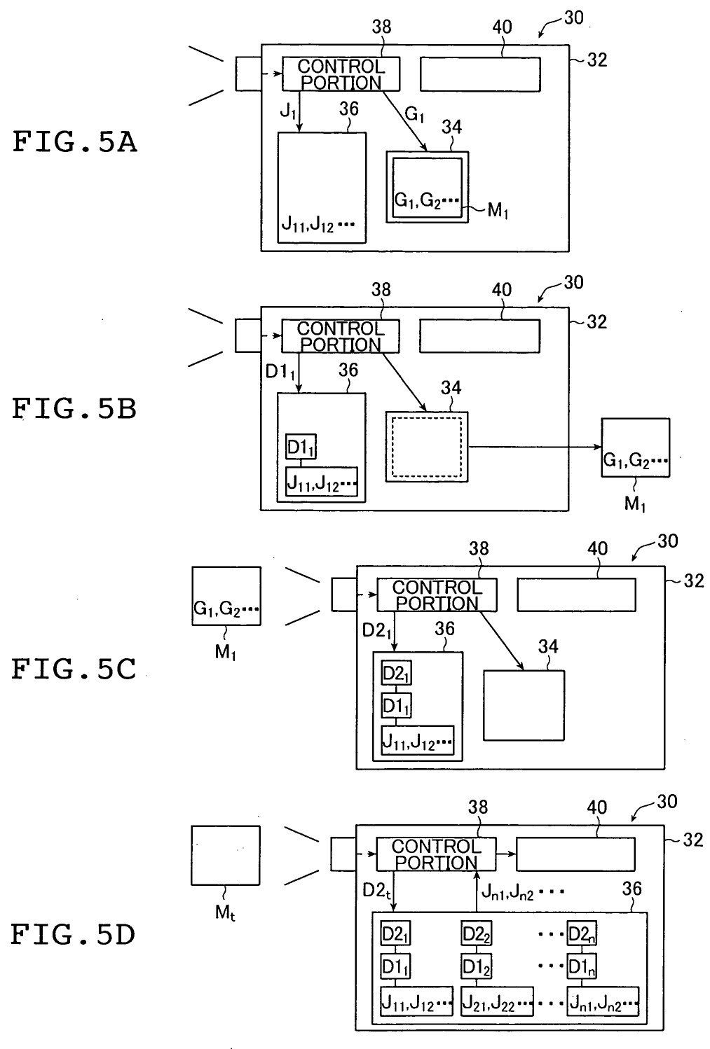

Next, a fifth embodiment of the present invention will be described. FIGS. 5A to 5D are each a conceptual diagram showing a schematic construction of the fifth embodiment of the content reference system according to the present invention. A content reference system 30 shown in the drawings is constructed as a digital camera 32 and the digital camera 32 includes a recording medium mounting portion 34 to which a recording medium M is mounted, an internal memory 36, a control portion 38, and a display portion 40. The content reference system 30 takes a moving image or a still image using the digital camera 32 and records image data G of the image (corresponding to contents C) onto the recording medium M mounted to the recording medium mounting portion 34. In addition, the content reference system 30 stores outline data J of the image data G (corresponding to the outline data I) in the internal memory 36 and also stores identification information D2 of the recording medium M in the internal memory 36 so as to be associated with the outline data J. Following this, when it is desired to confirm the photographed image data G recorded on the recording medium M, the content reference system 30 detects the corresponding outline data J from the internal memory 36 and displays the detected outline data J on the display portion 40.

It is also possible to say that the content reference system 30 corresponds to a construction where construction elements corresponding to the home server 12, the recording device 14, and the portable device 16 of the content reference system 10 shown in FIGS. 1A to 1C are integrated with each other. That is, the internal memory 36 and the control portion 38 of the content reference system 30 respectively correspond to the storage portion 18 and the control portion 20 of the home server 12 of the content reference system 10 and the recording medium mounting portion 34 and the digital camera 32 of the content reference system 30 respectively correspond to the recording device 14 and the portable device 16 of the content reference system 10.

The recording medium mounting portion 34 is a site where the recording medium M is mounted and writing of photographed image data G onto the recording medium M by the control portion 38 and other operations are performed. Also, the internal memory 36 is a memory where data is saved even when the digital camera 32 is powered off. Further, the control portion 38 controls the overall operation of the digital camera 32 such as writing and reading of data with respect to the recording medium mounting portion 34 and the internal memory 36, displaying of an image onto the display portion 40, photographing, and the like. Also, a sound recording and reproduction function may be provided for the digital camera 32.

At the digital camera 32, at the time of recording, as shown in FIG. 5A, photographed image data G₁ is saved in a recording medium M₁ mounted to the recording medium mounting portion 34 by the control portion 38 with a known technique. In addition, outline data J₁ of the photographed image data G₁ is created by the control portion 38 and is saved in the internal memory 36. Here, the outline data J₁ is small-sized data such as data of a thumbnail image of the photographed image data G₁, data of a still image in one frame of a moving image, or short-time sound data.

Next, as shown in FIG. 5B, when the photographing by the digital camera 32 and the saving of the photographed image data G1 (G₁₁, G₁₂, G₁₃, . . . , G₁ₙ) onto the recording medium M₁ are finished and extraction of the recording medium M₁ is instructed, the control portion 38 creates recording processing information D1₁ and saves the created recording processing information D1₁ in the internal memory 36 so as to be associated with the outline data J₁ (J₁₁, J₁₂, J₁₃, . . . , J₁ₙ) saved in the internal memory 36 in advance.

Then, as shown in FIG. 5C, the external appearance of the recording medium M₁ ejected from the digital camera 32 is photographed by the digital camera 32 immediately after the ejection. Photographed image data of the recording medium M₁ is set as identification information D2₁ and is recorded (registered) in the internal memory 36 as a set with the recording processing information D1₁.

By repeating the processing shown in FIGS. 5A to 5C described above where the recording onto the recording medium M and the registration of the recording medium M are performed, identification information D2 corresponding to multiple recording media M and outline data J of photographed image data G recorded on the respective recording media M are accumulated in the internal memory 36.

When it is desired to confirm photographed image data G recorded on a recording medium Mₜ at a later date (at the time of reference), as shown in FIG. 5D, first, identification information D2ₜ is obtained by photographing the recording medium Mₜ with the digital camera 32. Then, the control portion 38 checks the identification information D2ₜ against the identification information D2 group in the internal memory 36, identifies the recording medium Mₜ, and reproduces/displays corresponding outline data Jₜ on the display portion 40. When the outline data Jₜ contains sound data, the sound data is reproduced by a not-shown sound reproduction portion.

According to the first to fifth embodiments of the present invention described above, a photographed image of a recording medium M is set as identification information D2 and the identification information D2 and contents outline data I (outline data J) of contents C (photographed image data G) recorded on the recording medium M are stored in the home server 12 (digital camera 32) so as to be associated with each other. As a result, it becomes possible to confirm the contents C (photographed image data G) recorded on the recording medium M with ease by photographing the recording medium M.

Also, at the home server (or digital camera), recorded contents (or photographed image data) are managed using recording processing information obtained at the time of the recording of the contents onto a recording medium and the recording processing information is stored as a set with identification information of the recording medium on which the contents are recorded. As a result, it becomes possible to manage the recorded contents with precision at all times even when the recorded contents of the recording medium are updated.

Further, displaying of contents is performed through reproduction of contents outline data of the contents as an image or sound, so it becomes possible to perform confirmation of the contents of a recording medium precisely.

Next, a search for a recording medium M with reference to contents outline data I (outline data J) in the content reference systems 10 to 10c and 30 described above will be described.

As described above, with the content reference systems 10 to 10c and 30, it becomes possible to know the recorded contents of a recording medium Mₜ by photographing the recording medium Mₜ using the portable device 16 (16b) or the digital camera 32. With the content reference systems, however, it also becomes possible to conversely search for a recording medium M, out of multiple recording media M, on which specific contents C (photographed image data G) are recorded.

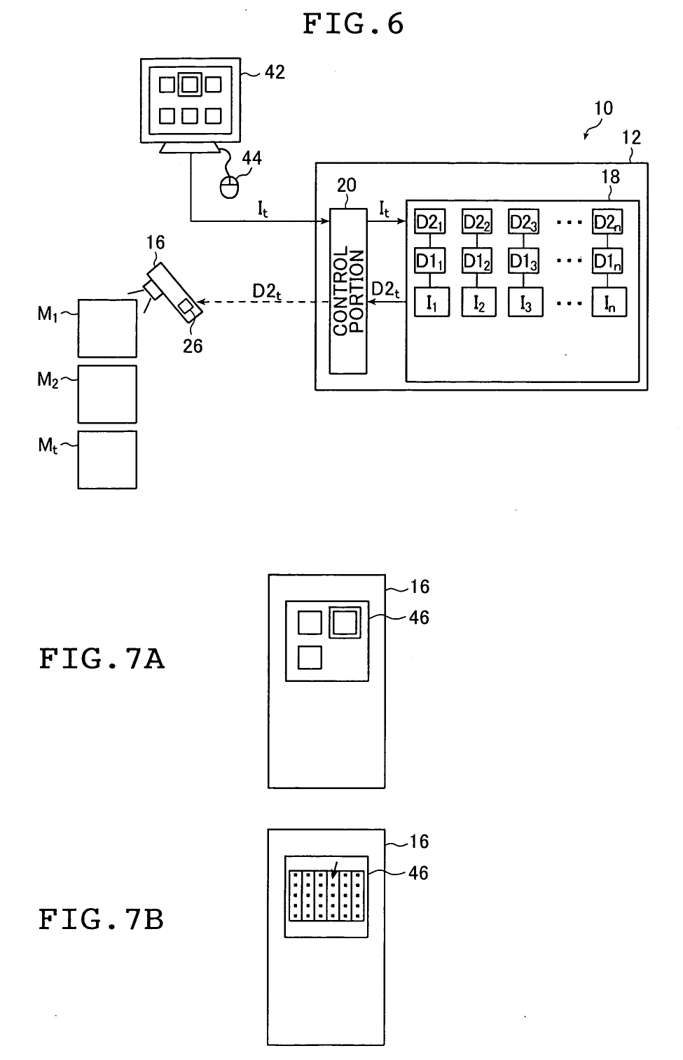

FIG. 6 shows the outline of a system construction for searching for a recording medium M by the content reference system 10 (see FIGS. 1A to 1C) that is the first embodiment. In FIG. 6, the content reference system 10 has a construction where a monitor 42 connected to a home server 12 and managed by the home server 12 and an instruction input means 44 for performing instruction input into the home server 12 are provided in addition to each construction element shown in FIG. 1. In addition, a control portion 26 and a display portion 46 possessed by the portable device 16 are also illustrated in the drawings.

It is assumed that multiple pieces of contents outline data I, multiple pieces of recording processing information D1, and multiple pieces of data of identification information D2 of recording media M are already accumulated in the storage portion 18 of the home server 12.

At the time of a search for the recording medium M, an instruction to display a contents outline is inputted by a user from the instruction input means 44 and a contents outline data I group stored in the storage portion 18 is list-displayed on the monitor 42 of the home server 12. Next, when outline data Iₜ of specific contents Cₜ is designated using the instruction input means 44, the control portion 20 detects recording processing information D1ₜ corresponding to the contents outline data Iₜ from the storage portion 18, reads identification information D2ₜ stored as a set with the recording processing information D1ₜ, and transfers the identification information D2ₜ to the portable device 16.

On the other hand, the external appearances of the multiple recording media M (there are three recording media M₁, M₂, and Mₜ in the illustrated example) that are search targets are photographed by the portable device 16 in succession or by one operation. Images of the photographed recording media M₁, M₂, and Mₜ are displayed on the display portion 46 one by one or at the same time.

At the portable device 16, the control portion 26 compares image data of the recording media M₁, M₂, and Mₜ obtained through the photographing with the recording medium identification information D2ₜ transferred from the home server 12 through image recognition (pattern matching) and specifies a recording medium M having predetermined or higher similarity, thereby detecting a recording medium Mₜ corresponding to the identification information D2ₜ.

On the display portion 46 of the portable device 16, a certain mark is displayed so as to be superimposed on a photographed scene of the corresponding recording medium Mₜ among the photographed recording media M₁, M₂, and Mₜ. For instance, when the respective photographed images of the recording media M₁, M₂, and Mₜ are displayed in succession on the display portion 46, it is sufficient that when the corresponding recording medium Mₜ is displayed, a notification is issued by, for instance, displaying the mark or outputting sound. Also, as shown in FIG. 7A, the mark may be displayed for the corresponding recording medium Mₜ among the multiple recording media M₁, M₂, and Mₜ displayed on the display portion 46. Further, as shown in FIG. 7B, when the multiple recording media M arranged on a shelf are photographed by one operation, for instance, it is sufficient that an arrow, a surrounding mark, or the like is displayed for the corresponding recording medium Mₜ in the image.

In this embodiment, image recognition where the photographed image data of the recording media M is compared with the recording media identification information D2ₜ transferred from the home server 12 is performed at the control portion 26 of the portable device 16, but this image recognition may be performed at the control portion 20 of the home server 12. For instance, it is sufficient that image data (identification information D2) of the multiple recording media M that are search targets is obtained by the portable device 16 and is transferred to the home server 12, the identification information D2 from the portable device 16 and the identification information D2ₜ detected in advance are compared with each other through image recognition at the control portion 20 of the home server 12, matching identification information D2 is returned to the portable device 16, and a matching mark is displayed on the display portion of the portable device 16. Also, the matching mark may be synthesized with the matching identification information D2 at the control portion 20 and then is returned to the portable device 16.

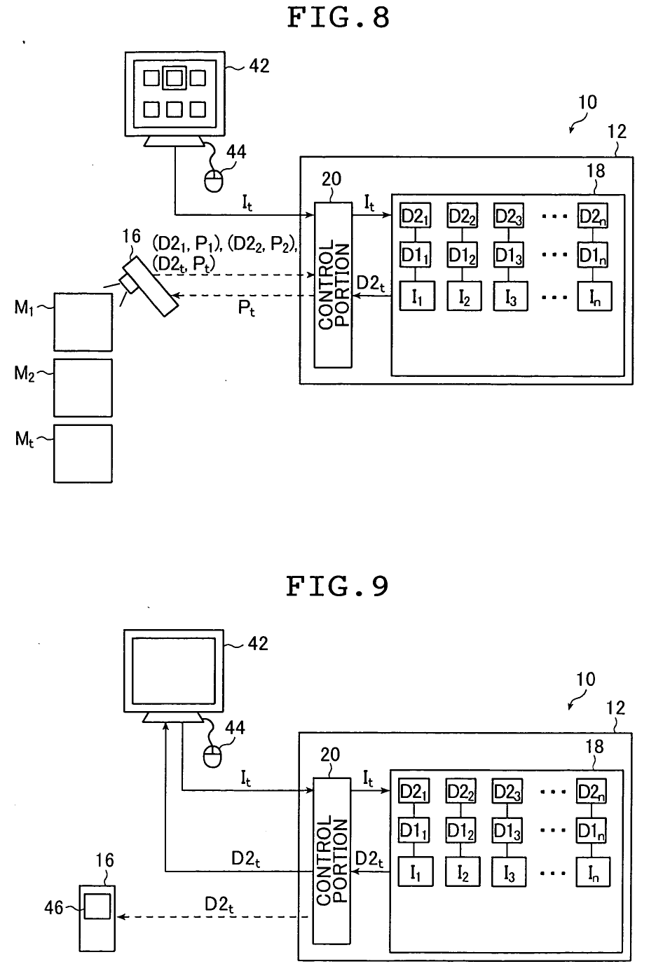

Alternatively, as shown in FIG. 8, image data of the recording media M photographed by the portable device 16 may be transferred to the home server 12 as the identification information D2 together with information P showing a position at which each piece of identification information D2 is displayed on the display portion (46) of the portable device 16, and the information P showing the display position of the matching identification information D2 is returned to the portable device 16 with reference to a result of detection at the control portion 20 of the home server 12.

Still alternatively, as shown in FIG. 9, after specific contents outline data Iₜ is designated from the contents outline data I group list-displayed on the monitor 42, an image by the identification information D2ₜ of the recording medium corresponding to the contents outline data It detected at the control portion 20, that is, a photographed image of the recording medium Mₜ may be displayed on the monitor 42 or the display portion 46 of the portable device 16, thereby allowing a user to conduct a visual search.

It is of course possible to list-display the contents outline data I in units of the photographed images (identification information D2) of the recording media on the monitor 42 of the home server 12 or the display portion 46 of the portable device 16.

Next, an operation at the time of a search for a recording medium M in the content reference system 10a (see FIGS. 2A and 2B) will be described.

In the content reference system 10a, contents outline data I and data of recording processing information D1 are accumulated in the storage portion 18 of the home server 12. Also, through photographing of the labels L of the recording media M by the portable device 16, the recording processing information D1 is obtained from the recording processing information D1′ of the recording media M.

Accordingly, like in the example described above, when the contents outline data Iₜ of specific contents Cₜ is designated, the control portion 20 of the home server 12 detects the recording processing information D1ₜ corresponding to the contents outline data Iₜ from the storage portion 18. On the other hand, the recording processing information D1₁′, D1₂′, D1ₜ′, and the like and the recording processing information D1₁, D1₂, D1ₜ, and the like are obtained by photographing the labels L₁, L₂, Lₜ, and the like of the recording media M₁, M₂, Mₜ, and the like using the portable device 16. Then, the control portion 20 of the home server 12 or the control portion 26 of the portable device 16 performs image recognition (pattern matching) and detects a recording medium Mₜ having a label Lₜ corresponding to the recording processing information D1ₜ.

Like in the example described above, the search result is displayed on the display portion 46 of the portable device 16 or the monitor 42 of the home server 12.

Next, a search for a recording medium M in the content reference system 10b (see FIGS. 3A to 3C) that is the third embodiment or the content reference system 10c (see FIGS. 4A to 4C) that is the fourth embodiment will be described.

In the content reference systems 10b and 10c, the contents outline data I and data of the recording processing information D1 are accumulated in the storage portion 18 of the home server 12 and the data of the recording processing information D1 and data of the identification information D2 are accumulated in the storage portion 24 of the portable device 16b.

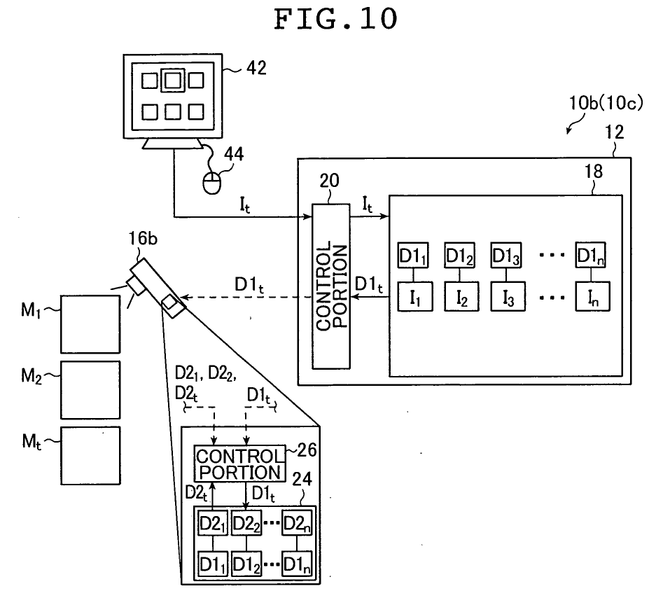

Accordingly, as shown in FIG. 10, at the time of a search for the recording medium M, specific contents outline data Iₜ in the contents outline data I group displayed on the monitor 42 of the home server 12 is designated using the instruction input means 44. Then, at the home server 12, recording processing information D1ₜ corresponding to the contents outline data Iₜ is detected and is transferred to the portable device 16b. At the portable device 16b, the control portion 26 detects recording processing information D1 (that is, D1ₜ) coinciding with the recording processing information D1ₜ transferred from the home server 12 from the storage portion 24 and reads identification information D2ₜ corresponding to the recording processing information D1ₜ.

Also, at the portable device 16b, the external appearances of multiple recording media (there are three recording media M₁, M₂, and Mₜ in the illustrated example) that are search targets are photographed in succession or by one operation. Then, the control portion 26 compares images of the photographed recording media M with the identification information D2ₜ detected and read in advance through image recognition, thereby specifying a recording medium M having predetermined or higher similarity.

Following this, like in the example described above, a search result is displayed on the display portion 46 of the portable device 16 or the monitor 42 of the home server 12.

Next, an operation at the time of a search for a recording medium M in the content reference system 30 (see FIGS. 5A to 5D) will be described. In the content reference system 30, an outline data J group stored in the internal memory 36 of the digital camera 32 is displayed on the display portion 40 and when specific outline data Jₜ is designated from the group by a user or the like, the control portion 38 detects recording processing information D1ₜ corresponding to the designated outline data Jₜ and reads recording medium identification information D2ₜ that is a set with the recording processing information D1ₜ.

Also, multiple recording media M₁, M₂, Mₜ, and the like that are search targets are photographed by the digital camera 32.

Then, the control portion 38 compares photographed image data of the recording media M₁, M₂, Mₜ, and the like obtained through the photographing with the recording media identification information D2ₜ read from the internal memory 36 through image recognition, specifies a recording medium Mₜ corresponding to the identification information D2ₜ, and displays a certain mark so as to be superimposed on the image of the recording medium Mₜ displayed on the display portion 40.

As described above, according to the first to fifth embodiments of the present invention, it also becomes possible to perform a search for a recording medium M, on which specific contents C (photographed image data G) are recorded, with ease using the outline data I (J) of the contents C (photographed image data G).

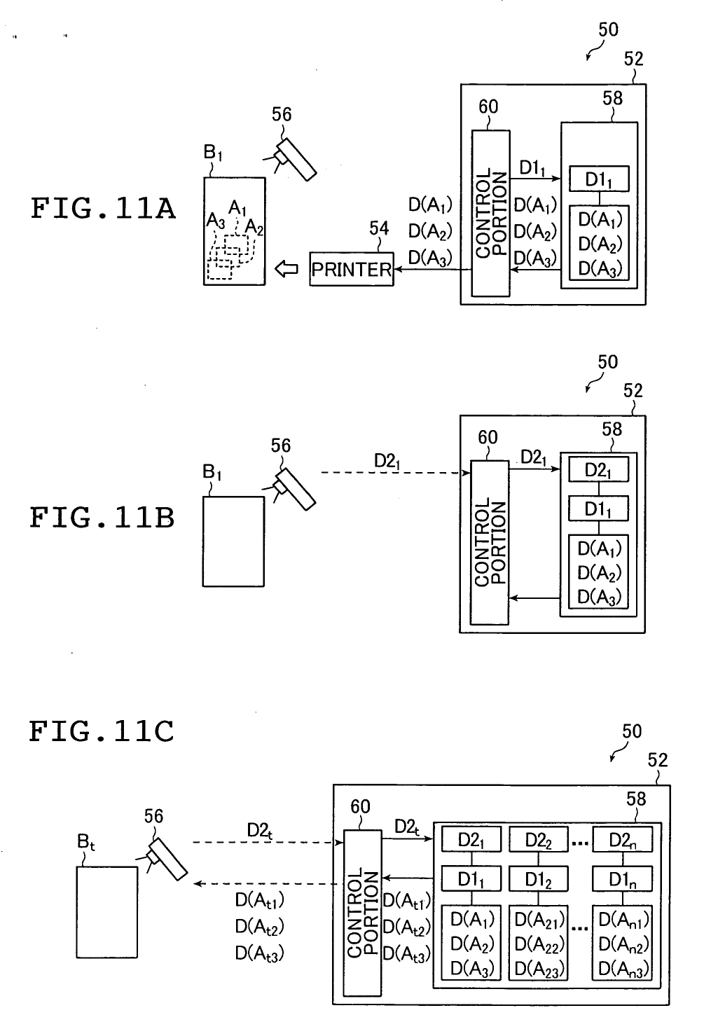

Next, a sixth embodiment of the present invention will be described. FIGS. 11A to 11C are each a conceptual diagram showing a schematic construction of the sixth embodiment of the present invention.

In the first to fourth embodiments described above, the contents main body data C stored in the home server 12 is recorded on the recording medium M by the recording device 14 and the information for associating the recording medium M and the contents outline data I with each other is stored in the home server 12 or the portable device 16. In contrast to this, in this embodiment, a printer 54 that creates prints A by recording visible images on recording media, such as paper, is provided in place of the recording device 14, a container file B containing one or more prints A is used in place of the recording medium M on which one or more contents C are recorded, and information for associating the container file B and the prints A contained in the container file B with each other is stored, thereby making it possible to know what prints A are contained in the container file B.

A content reference system 50 in FIGS. 11A to 11C includes a printer server 52, a printer 54 connected to the printer server 52, and a portable device 56. The printer server 52 includes a storage portion 58 and a control portion 60, with image data D (A) inputted from a not-shown image data input means being stored in the storage portion 58. Even when the image data D (A) is outputted to the printer 54, its replication data is maintained in the storage portion 58. It is preferable that the image data D (A) maintained in the storage portion 58 is outline data of the image data D (A) for printing, that is, index image data, thumbnail image data, or the like whose size is reduced from that of the data for printing outputted to the printer 54. Alternatively, it is also preferable that the image data D (A) for printing and small-sized image data corresponding to the outline data are stored separately in the storage portion 58 from the beginning.

The control portion 60 corresponds to the control portion 20 of the home server 12 in the content reference system 10 and performs processing such as writing and reading of data with respect to the storage portion 58, control of the printer 54 connected to the printer server 52, and the like.

Also, the portable device 56 has the same construction as the portable device 16 in the content reference system 10.

At the time of output of prints A₁, A₂, and A₃ (at the time of recording), as shown in FIG. 11A, image data D (A₁), D (A₂), and D (A₃) stored in the storage portion 58 are read out by the control portion 60 and are transmitted to the printer 54 and the prints A₁, A₂, and A₃ are created by the printer 54. In addition, the control portion 60 creates recording processing information D1₁ concerning the recording of the prints A₁, A₂, and A₃ and stores the created recording processing information D1₁ in the storage portion 58 so as to be associated with the image data D (A₁), D (A₂), and D (A₃) (or outline data thereof) of the prints A.

The prints A₁, A₂, and A₃ outputted from the printer 54 are put in a container file B₁ by a user one by one or collectively.

Here, the container file B is not specifically limited so long as it is capable of containing the prints A. For instance, it is possible to use a bag, an album, or a container case as the container file B. However, like in the case of the recording media M in each embodiment described above, it is required that it is possible to identify each container file B by its external appearance.

Then, immediately after the prints A₁, A₂, and A₃ outputted from the printer 54 are contained in the container file B₁, as shown in FIG. 11B, the external appearance of the container file B₁ is photographed by the portable device 56. Image data of the container file B₁ is transferred from the portable device 56 to the printer server 52 as identification information D2₁ of the container file B₁ and is stored (registered) by the control portion 60 in the storage portion 58 as a set with the recording processing information D1₁ stored in the storage portion 58 in advance.

By repeating the processing described above, multiple pieces of print image data D (A) and identification information D2 of multiple container files B containing prints A are accumulated in the storage portion 58 of the printer server 52.

When it is desired to confirm what contents (prints A) are contained in a container file Bt at a later date (at the time of reference), as shown in FIG. 11C, the external appearance of the container file Bₜ is photographed by the portable device 56 and identification information D2ₜ of the container file Bt is transmitted to the printer server 52. On receiving the identification information D2ₜ, at the printer server 52, the control portion 60 detects identification information D2 coinciding with the identification information D2ₜ from the identification information D2 group in the storage portion 58, detects recording processing information D1ₜ stored as a set with the identification information D2ₜ, and returns every piece of image data D (A) associated with the recording processing information D1ₜ to the portable device 56. Then, at the portable device 56, images of the prints A contained in the container file Bₜ are reproduced in succession or at the same time.

It should be noted here that in order to distinguish between the transfer of the identification information D2 of the container file B by the portable device 56 at the time of the reference and the transfer of the identification information D2 at the time of the registration, a selection from among a reference mode and a registration mode is made at the portable device 56 or the printer server 52 prior to the data transfer from the portable device 56. Also, data communication between the portable device 56 and the printer server 52 at the time of the registration and the reference may be performed through the printer 54.

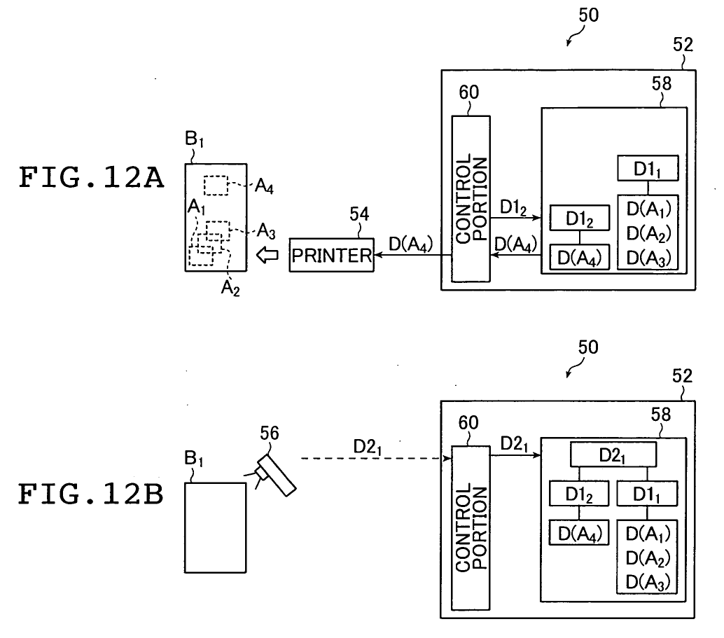

FIGS. 12A and 12B show a method for registering a container file B in the case where in the content reference system 50, a new print A₄ is outputted from the printer 54 and is additionally contained in the container file B in which prints A₁ to A₃ are already contained.

As shown in FIG. 12A, when the print A₄ is outputted, recording processing information D1₂ is created and is stored in the storage portion 58. Following this, when the print A₄ outputted from the printer 54 is contained in the container file B₁ in which the prints A₁ to A₃ are already contained, as shown in FIG. 12B, the container file B₁ is photographed by the portable device 56 and identification information D2₁ of the container file B₁ is transferred to the printer server 52.

The control portion 60 of the printer server 52 receives the identification information D2₁ of the container file B₁. Following this, when recognizing that the identification information D2₁ coincides with identification information D2₁ already stored in the storage portion 58, the control portion 60 stores both of the recording processing information D1₂ of image data D (A₄) and recording processing information D1₁ of image data D (A₁) to D (A₃) in the storage portion 58 as a set with the identification information D2₁. As a result, the identification information D2₁ of the container file B₁ and the image data of the prints A₁ to A₄ are stored so as to be associated with each other.

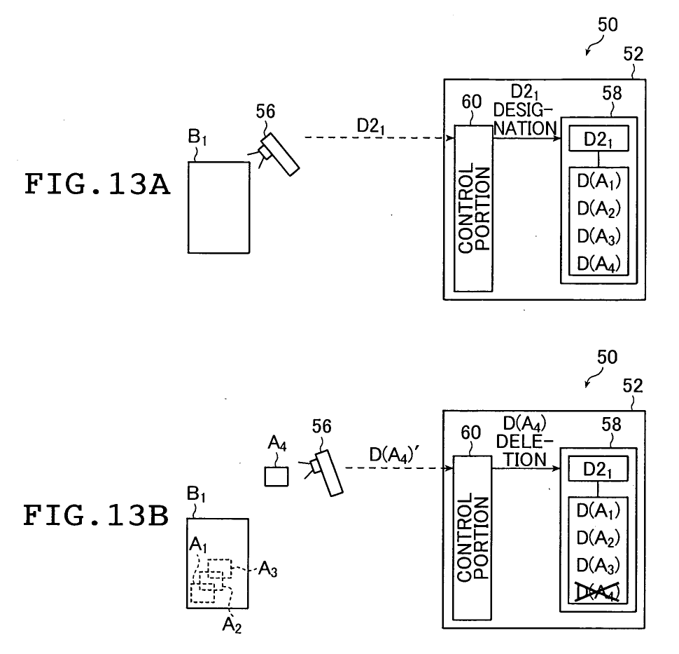

FIGS. 13A and 13B each show a method for registering the container file B in the case where in the content reference system 50, one of the prints A₁ to A₄ contained in the container file B is taken out. When one of the prints A₁ to A₄ is taken out from the container file B₁, first, a deletion mode is set at the portable device 56 or the printer server 52. Then, as shown in FIG. 13A, the container file B₁ is photographed by the portable device 56 and identification information D2₁ of the container file B₁ is transferred to the printer server 52. At the printer server 52, the control portion 60 receives the identification information D2₁ of the container file B₁ in the deletion mode and recognizes that a container file that is a target is the container file B₁.

Next, as shown in FIG. 13B, the print A₄ taken out from the container file B₁ is photographed by the portable device 56 and its image data D (A₄)′ is transferred to the printer server 52. The control portion 60 of the printer server 52 detects image data D (A₄), whose image characteristic amount is the most similar to that of the image data D (A₄)′, from an image data D (A) group stored so as to be associated with the identification information D2₁ of the container file B₁ that is the deletion target recognized in advance and deletes the image data D (A₄) from the image data D (A) group associated with the identification information D2₁. Through this processing, the identification information D2₁ of the container file B₁ and the image data of the prints A₁ to A₃, from which the data of the print A₄ has been eliminated, are stored so as to be associated with each other.

It should be noted here that the registration of the container file B in the case where the print A is taken out from the container file B may be performed using the following method where switching to the deletion mode is not performed. That is, for instance, a method may be used with which when the portable device 56 transfers the identification information D2 that is the photographed image data of the container file B and the photographed image data of the print A to the printer server 52 continuously under a state where recording of the print A is not performed, the deletion mode is automatically set and the image data of the print A is deleted from the data group associated with the identification information D2 of the container file B at the printer server 52. Also, in this case, like at the time of reference, the image data D (A) group associated with the identification information D2 may be returned from the home server 12 to the portable device 56.

As described above, according to the sixth embodiment of the present invention, it becomes possible to confirm the contents of (prints (paper media) contained in) a container file by photographing the container file. In addition, it also becomes possible to cope with addition of a print into a container file, in which any prints are already contained, and taking out of a print from a container file through a simple operation, so it becomes possible to perform file management with ease and precision.

Even in the content reference system 50, like in the case of the content reference system 10 and the like described above, it is also possible to use a certain print A that is a content as a search key to retrieve a container file B that contains the print A. It is possible to search for the container file B containing the print A and display a result of the search with a method that is the same as the method described above with reference to FIGS. 6 to 9. That is, it is sufficient that multiple images A′ by multiple pieces of image data D (A) stored in the storage portion 58 of the printer server 52 are displayed on the portable device 56 or a monitor (not shown) connected to the printer server 52, a user designates an image Aₜ′ from among the multiple images A′, a search is conducted at the printer server 52 based on the image data D (Aₜ) of the image Aₜ′, and a photographed image of a corresponding container file Bₜ is displayed as a search result on the portable device 56 or the monitor of the printer server 52 so as to be distinguishable from other container files B.

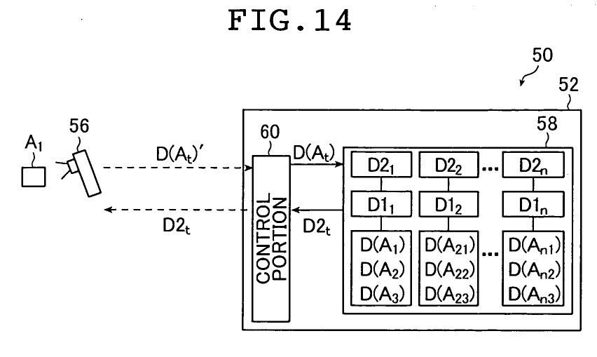

Also, in this embodiment where the contents C are the prints A, it is also possible to search for a container file Bₜ, in which a print Aₜ should be contained, by photographing the print Aₜ with the portable device 56. Such an example is shown in FIG. 14.

In the example in FIG. 14, first, an image recorded on the print Aₜ is photographed using the portable device 56. Then, photographed data D (Aₜ)′ is transferred to the printer server 52. At the printer server 52, the control portion 60 detects image data D (Aₜ) coinciding with the photographed data D (Aₜ)′ from the image data D (A) group stored in the storage portion 58 and returns container file identification information D2ₜ corresponding to the image data D (Aₜ) to the portable device 56.

At the portable device 56, a method may be used with which the container file identification information D2ₜ sent from the printer server 52 is merely displayed on the display portion. Alternatively, a method may be used with which multiple container files B that are search targets are photographed with the portable device 56, image recognition (pattern matching) is performed at the portable device 56 or the printer server 52, a container file Bₜ corresponding to the identification information D2ₜ is detected out of the multiple container files B photographed with the portable device 56, and displaying on the display portion of the portable device 56 or the monitor of the printer server 52 is performed so that the corresponding container file Bₜ is distinguished from other container files B.

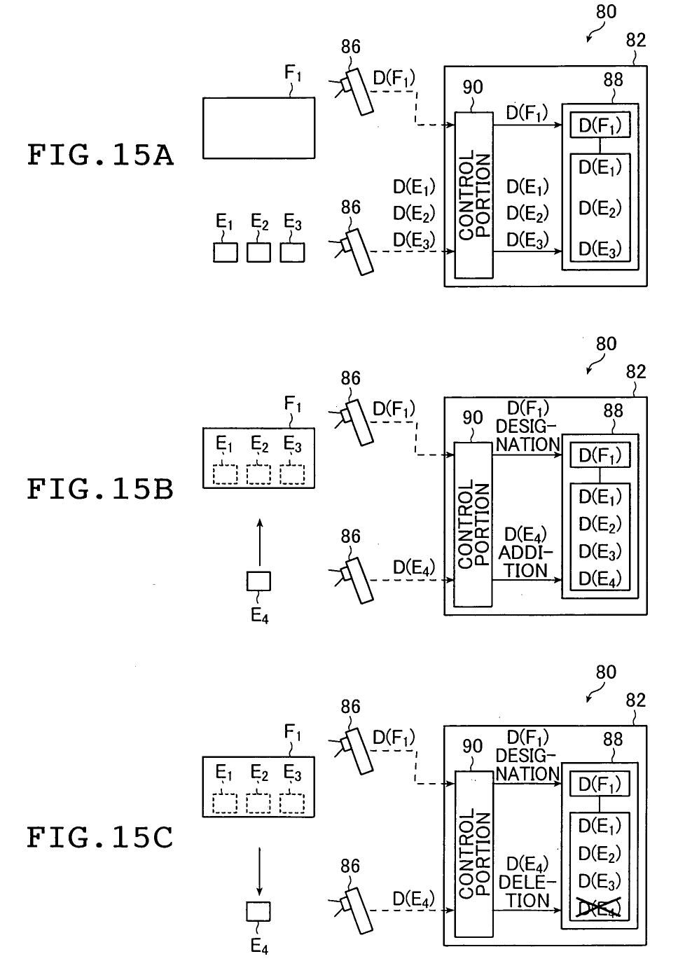

Next, a seventh embodiment of the present invention will be described. FIGS. 15A to 15C are each a conceptual diagram showing a schematic construction of the seventh embodiment of the present invention. A content reference system 80 shown in the drawings includes a home server 82 corresponding to the home server 12 of the first embodiment (see FIGS. 1A to 1C) described above and a portable device 86 corresponding to the portable device 16. The content reference system 80 is a system where photographed image data of articles E is obtained as contents C by the portable device 86, photographed image data of an container case F (corresponding to the recording medium M in the example shown in FIGS. 1A to 1C), in which the articles E are contained, is obtained by the portable device 86, and both data is stored in the home server 82 so as to be associated with each other, thereby making it possible to know what articles E are contained in the container case F at a later date.

Here, it is possible to consider various articles E and container cases F. For instance, the articles E may be cloths and the container case F may be a chest, a clothes case, or the like. Alternatively, the articles E may be food and the container case F may be a refrigerator or the like. Also, like in the case of the recording media M or the container files B in the embodiments described above, it is required that it is possible to identify each container case F by its external appearance.

In the content reference system 80, an article mode, in which an article E group is photographed, and a container mode, in which the container case F is photographed, are prepared and switching between the article mode and the container mode is performed by the portable device 86 or the home server 82 in accordance with whether the articles E or the container case F are/is to be photographed.

In the content reference system 80, at the time of recording/registration of the articles E and the container case F, as shown in FIG. 15A, articles E₁, E₂, E₃, and the like are photographed by the portable device 86 and photographed image data D (E₁) to D (E₃) are obtained. In addition, a container case F₁, in which the articles E₁, E₂, E₃, and the like are contained, is photographed and photographed image data D (F) is obtained. The obtained photographed image data D (E₁) to D (E₃) and D (F) are transferred to the home server 82 and are stored in a storage portion 88 by a control portion 90 of the home server 82 so as to be associated with each other. Note that the photographed image data D (E) of the articles E and the photographed image data D (F) of the container case F respectively correspond to the contents C and the identification information D2 in the example shown in FIGS. 1A to 1C.

When an article E₄ is additionally contained in the container case F₁, as shown in FIG. 15B, photographed image data D (F₁) of the container case F₁ and image data D (E₄) of the article E₄ to be additionally contained are obtained by the portable device 86 and are transferred to the home server 82.

At the home server 82, it is recognized that the photographed image data D (F₁) coincides with the photographed image data D (F₁) already stored in the storage portion 88 and the photographed image data D (E₄) is stored as a set with the photographed image data D (E₁) to D (E₃) already stored so as to be associated with the photographed image data D (F₁).

When the article E₄ is taken out from the container case F₁, under a state where the portable device 86 or the home server 82 is set in a deletion mode, as shown in FIG. 15C, photographed image data D (F₁) of the container case F₁ and image data D (E₄) of the taken-out article E₄ are obtained by the portable device 86 and are transferred to the home server 82.

At the home server 82, the photographed image data D (F₁) is received in the deletion mode, so it is recognized that a deletion target is the photographed image data D (F₁). Following this, image data D (E) coinciding with the received image data D (E₄) is detected from among the data associated with the photographed image data D (F₁) and is deleted.

In this manner, the data of the articles E and the container case F is accumulated in the storage portion 88 of the home server 82.

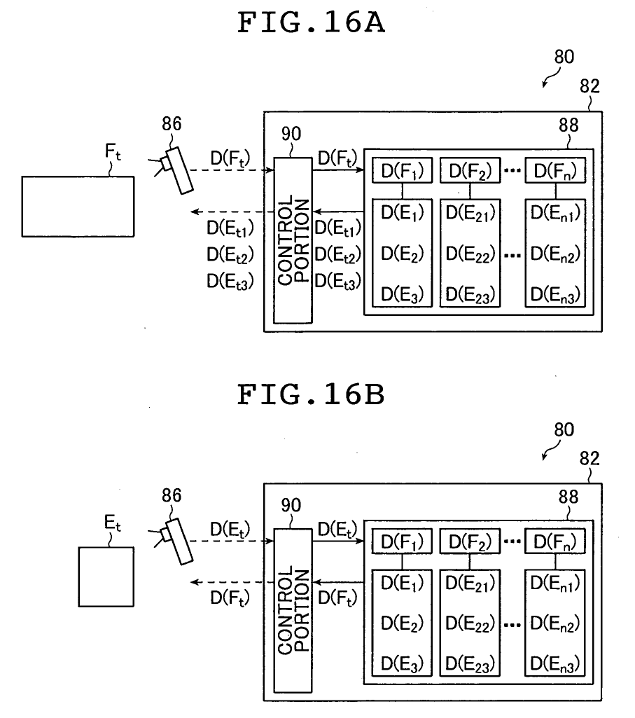

When it is desired to confirm the contents of (articles E contained in) the container case F at a later date (at the time of reference), as shown in FIG. 16A, the external appearance of the container case Fₜ is photographed by the portable device 86 and photographed image data D (Fₜ) of the container case Fₜ is transmitted to the home server 82. At the home server 82, on receiving the photographed image data D (Fₜ), the control portion 90 detects image data D (F) coinciding with the photographed image data D (Ft) from the photographed image data D (F) group in the storage portion 88 and returns every piece of photographed image data D (E) associated with the image data D (Fₜ) to the portable device 86. Then, at the portable device 86, images of all of the articles E contained in the container case Fₜ are reproduced in succession or collectively at the same time or multiple times.

Also, when a certain article Eₜ is not at hand and it is desired to search for a container case Fₜ in which the article Eₜ is contained, it is possible to perform the search and displaying of a search result with a method that is the same as the method described above with reference to FIGS. 6 to 9. That is, it is sufficient that an article E group stored in the storage portion 88 of the home server 82 is displayed on the portable device 86 or a monitor (not shown) connected to the home server 82, a user designates the article Eₜ from the displayed article E group, a search is conducted at the home server 82 based on photographed image data D (Eₜ) of the article Eₜ, and a photographed image of a corresponding container case Fₜ is displayed as a search result on the portable device 86 or the monitor of the home server 82 so as to be distinguishable from other container cases F.

Also, when a certain article Eₜ is at hand and it is desired to search for a container case Fₜ in which the article Eₜ should be contained, it is sufficient that photographed image data D (Eₜ) of the article Eₜ is obtained by the portable device 86, a search is conducted at the home server 82 based on the obtained data, and a photographed image of a corresponding container case F is displayed on the display portion of the portable device 86 or the monitor of the home server 82 as a search result (see FIG. 16B).

As described above, according to the seventh embodiment of the present invention, it becomes possible to confirm the contents of (articles contained in) a container case by photographing the container case. In addition, it also becomes possible to know a container case containing a certain article with ease by photographing the article or selecting the article at the home server 82. In addition, it further becomes possible to cope with addition of an article into a container case, in which any articles are already contained, and taking out of an article from a container case through a simple operation, so it becomes possible to perform article containment and management with ease and precision.

The content reference method and content reference system according to the present invention have been described in detail above, but the present invention is not limited to the embodiments described above and it is of course possible to make various modifications and changes without departing from the gist of the present invention.

1. A content reference method comprising:
obtaining identification information of container medium in which contents are contained and which is identifiable by an external appearance thereof from photographic image data obtained by photographing the container medium;
storing the obtained identification information and contents data corresponding to the contents of the container medium in storage means in association with each other;
searching, when identification information of a certain container medium obtained by photographing the container medium is inputted, the storage means using the inputted identification information and detecting the identification information coinciding with the inputted identification information;
reading, from the storage means, the contents data stored in association with the detected identification information; and
reproducing/displaying contents of the certain container medium based on the read contents data.

2. The content reference method according to claim 1, wherein:
the contents are composed of digital data;
the container medium is a recording medium for the digital data; and
the contents data is outline data of the digital data of the contents.

3. The content reference method according to claim 1, wherein the photographing of the container medium for the obtainment of the identification information and the reproduction/display of the contents are performed by a portable device having a photographing function, a reproduction/display function, and a transmission/reception function.

4. A content reference method comprising:
obtaining photographed image data that is obtained by photographing container medium in which contents are contained and which is identifiable by an external appearance thereof, as identification information of the container medium;
storing the obtained identification information and contents data corresponding to the contents of the container medium in storage means in association with each other;
searching, when the contents data is inputted, the storage means using the inputted contents data and detecting the contents data coinciding with the inputted contents data;
reading, from the storage means, the identification information stored in association with the detected contents data; and
reproducing/displaying photographic image of the certain container medium based on the read identification information.

5. The content reference method according to claim 4, wherein:
the contents are composed of digital data;
the container medium is a recording medium for the digital data; and
the contents data is outline data of the digital data of the contents.

6. The content reference method according to claim 4, wherein the photographing of the container medium for the obtainment of the identification information and reproduction/display of a photographed image of the container medium are performed by a portable device having a photographing function, a reproduction/display function, and a transmission/reception function.

7. A content reference system comprising:
photographing means for photographing container medium in which contents are contained and which is identifiable by an external appearance thereof;
obtainment means for obtaining identification information of the container medium from photographic image data obtained by the photographing means;
storage means for storing the obtained identification information and contents data corresponding to the contents of the container medium in association with each other;
detection means for searching the storage means using the identification information of the container medium obtained by the obtainment means and detecting identification information coinciding with the obtained identification information;
reading means for reading, from the storage means, the contents data stored in association with the identification information detected by the detection means; and
reproducing/displaying means for reproducing/displaying the contents based on the contents data read by the reading means.

8. The content reference system according to claim 7, wherein the photographing means and the reproduction/display means are implemented by a portable device having a photographing function, a reproduction/display function, and a transmission/reception function.

9. The content reference system according to claim 7, further comprising: writing means for writing the identification information obtained by the obtainment means into the storage means in association with the contents data.

10. The content reference system according to claim 9, further comprising: recording means for recording the contents onto the container medium and generating recording processing information of the contents,
wherein the writing means writes the contents data and the identification information into the storage means in association with each other based on the recording processing information.

11. The content reference system according to claim 7,
wherein the contents are composed of digital data,
the container medium is a recording medium for the digital data, and
the contents data is outline data of the digital data of the contents.

12. A content reference system comprising:
photographing means for photographing container medium in which contents are contained and which is identifiable by an external appearance thereof;
obtainment means for obtaining photographic image data obtained by the photographing means as identification information of the container medium;
storage means for storing the obtained identification information and contents data corresponding to the contents of the container medium in association with each other;
reproduction/display means for reproducing/displaying the contents based on the contents data;
designation means for designating certain contents from among multiple contents reproduced/displayed by the reproduction/display means;
detection means for searching the storage means using the contents data of the contents designated by the designation means and detecting contents data coinciding with the contents data of the designated contents;
reading means for reading, from the storage means, identification information of a container medium stored in association with the contents data detected by the detection means; and
image display means for reproducing/displaying a photographic image of the container medium based on the identification information read by the reading means.

13. The content reference system according to claim 12, wherein the photographing means, the reproduction/display means, and the image display means are implemented by a portable device having a photographing function, a reproduction/display function, and a transmission/reception function.

14. The content reference system according to claim 12, further comprising: writing means for writing the identification information obtained by the obtainment means into the storage means in association with the contents data.

15. The content reference system according to claim 14, further comprising: recording means for recording the contents onto the container medium and generating recording processing information of the contents,
wherein the writing means writes the contents data and the identification information into the storage means in association with each other based on the recording processing information.

16. The content reference system according to claim 12, wherein:
the contents are composed of digital data,
the container medium is a recording medium for the digital data, and
the contents data is outline data of the digital data of the contents.
